(19) United States
(12) Patent Application Publication
(10) Pub. No.: US 2002/0065173 A1
(43) Pub. Date: May 30, 2002

(54) Exercise hoist

(76) Inventor: Gerry Cook, Sandpoint, ID (US)

Correspondence Address: Richard C. Conover, Suite 404, 104 East Main Street, P.O. Box 1329, Bozeman, MT, 59771-1329, US

(21) Appl. No.: 09/989,894

(22) Filed: Nov. 20, 2001

Related U.S. Application Data
(60) Provisional application No. 60/249,951, filed on Nov. 20, 2000.

(51) Int. Cl. A63B 22/00; A63B 22/02; A61H 3/00; A47D 13/04

(52) U.S. Cl. 482/69; 482/54

(57) ABSTRACT

The present invention includes an upright stand from which is suspended a vest and harness for holding a user. The vest and harness are connected to a cable which is in turn connected to a pneumatic cylinder. When pressurized air is delivered to the pneumatic cylinder, the cable is retracted pulling the vest holding a person upwardly. A control system is provided which includes three modes of operation. In the “off” mode, the pneumatic cylinder is vented to the atmosphere. In the “exercise” position, pressurized air, of selected pressure, is delivered to the pneumatic cylinder. In the “balance” mode, the air in the pneumatic cylinder is trapped within the pneumatic cylinder.

### SPECIFICATION

### BACKGROUND OF INVENTION

This invention relates to a pneumatic hoist for taking some body weight off of people's feet while they are exercising.

### BRIEF DESCRIPTION OF THE DRAWINGS

In order that the invention may be clearly understood and readily carried into effect, a preferred embodiment of the invention will now be described, by way of example only, with reference to the accompanying drawings wherein:

FIG. 1 is a left perspective photograph of the exercise hoist of the present invention having posts supporting the weight of people exercising;

FIG. 2 is a series of views showing multiple exercise hoists ganged together;

FIG. 3 is a front view schematic of a portion of only a single post shown in FIG. 1 with parts broken away to illustrate the positions of various components;

FIG. 4 is a left side view of a control panel shown in FIG. 3;

FIG. 5 is a waist-wrapping, body support shown in FIG. 1;

FIG. 6 is a schematic of a three way pneumatic valve;

FIG. 7 is a schematic of the pneumatic connections shown in FIG. 3;

FIG. 8 is a table showing various valve port connections for the two, three-way pneumatic valves used in this invention;

FIG. 9 is a schematic of the pneumatic connections of a second embodiment; and

FIG. 10 is a cross-sectional view of a valve used with the second embodiment.

### DESCRIPTION OF A PREFERRED EMBODIMENT

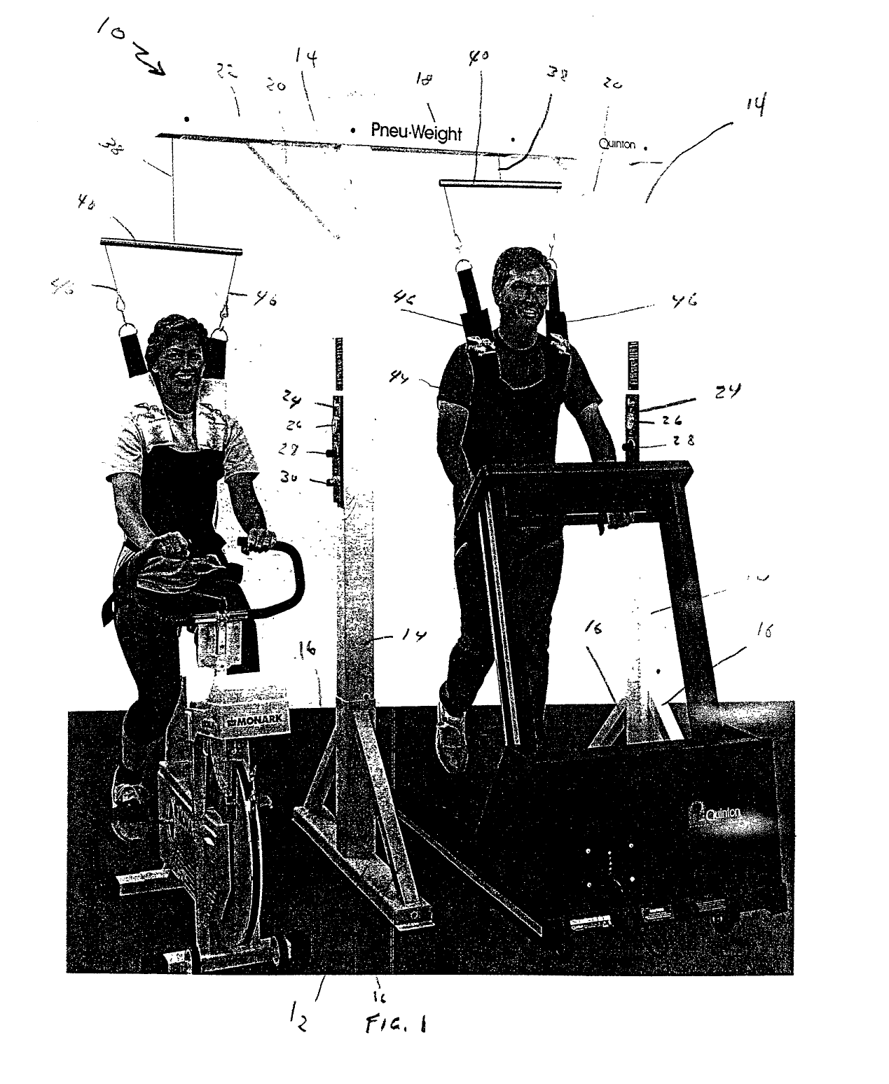

A photograph of a double exercise hoist 10 being used by two people is shown in FIG. 1. Since both sections of exercise hoist 10 operate similarly, only a single section will be described in the detailed description that follows. Exercise hoist 10 has a base 12 which rests on a floor. A post 14, connected substantially perpendicular to the mid section of base 12, extends away from the base. Post 14 has braces 16 on opposite sides of the post, extending between the post and the base and connected to both, to add rigidity to the structure. At the end of post 14 opposite base 12, a header 18, connected substantially perpendicular to post 14 at one end of the header, extends away from the post. A brace 20, extending between header 18 and post 14 and fixedly connected to both, again increase the rigidity of the structure.

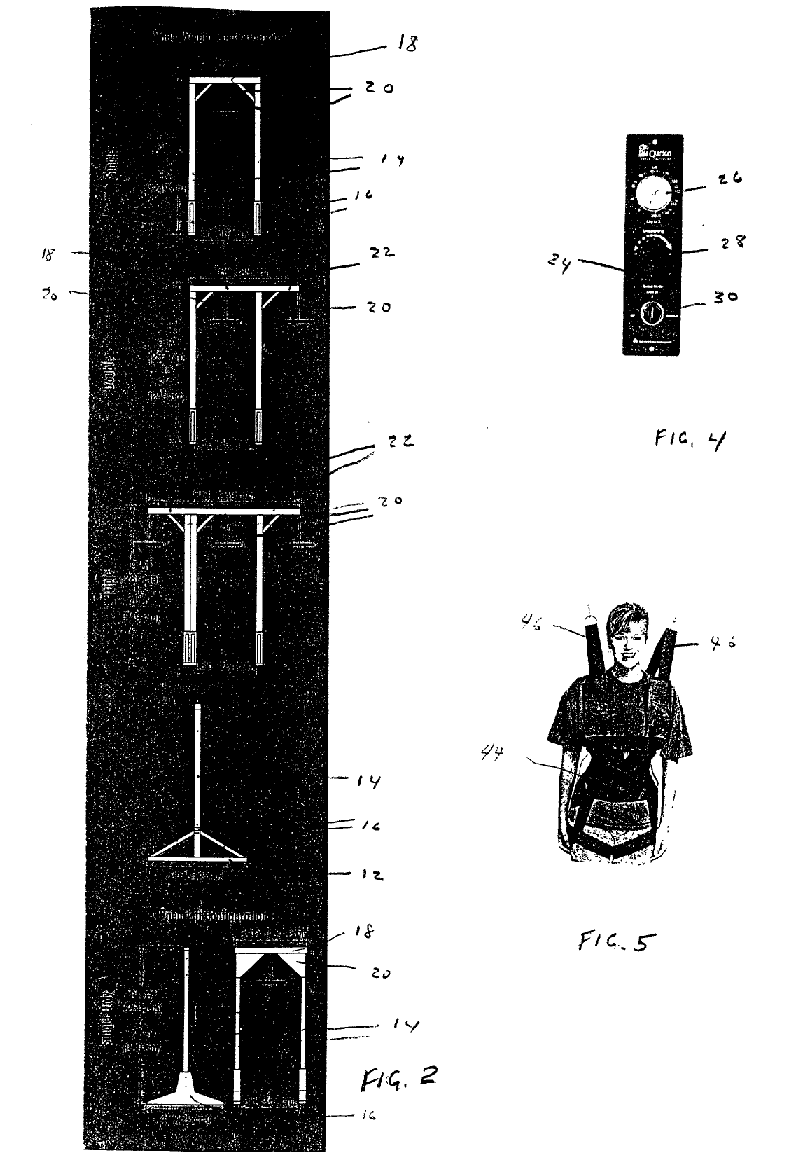

In a single structure, a second post 14 with associated brace 20, together with a base 12 and braces 16 and 20, is connected at the opposite end of header 18 in substantially the same plane as post 14 as shown at the top of FIG. 2. These dual post 14 structures rigidly support header 18 when used for a single structure but use only a single control panel 24 facing in toward the exercise space in one of the posts. For a dual structure, a cantilevered header 22, as shown in FIG. 1, is used to connect to and extend from one side of a post 14. Additional structures can be ganged together to make larger structures as shown in the other drawings of FIG. 2 again with a single control panel 24 facing into each exercise space. Each individual unit works in the same basic manner as will be described in the following paragraphs.

As shown in FIG. 3, all the various elements of the present invention can be placed in a single post 14 together with either a header 18 or header 22. A single control panel 24 is exposed on a side of post 14 closest to a person exercising. On the exposed side, control panel 24, as shown in FIG. 4, has a pressure gauge 26, a regulator adjustor 28, and a selection mode switch 30 all within view, and reach of, a person exercising.

As best seen in FIG. 3, a pressure tank 32 is placed inside post 14 intermediate control panel 24 and base 12. A pneumatic cylinder 34, having a shaft 36 and an internal piston 37, is placed inside post 14 intermediate control panel 24 and header 18. Shaft 36, connected to internal piston 37 within pneumatic cylinder 34, extends away from control panel 24 at one end of the pneumatic cylinder. Pneumatic tubing 35 is used to connect various pneumatic elements. As pressure is introduced into pneumatic cylinder 34 at an end of the cylinder furthest removed from control panel 24, shaft 36 retracts into the pneumatic cylinder in a direction that moves the shaft toward the control panel.

A cable 38, at one end is connected to shaft 36. At the other end, cable 38 is connected near the midpoint of exercise bar 40. Intermediate the ends of cable 38, pulleys 42 change the direction of applied tension so as to conform cable movements to an installation within a header (either header 18 or header 22) and a post 14 as shown in FIG. 3.

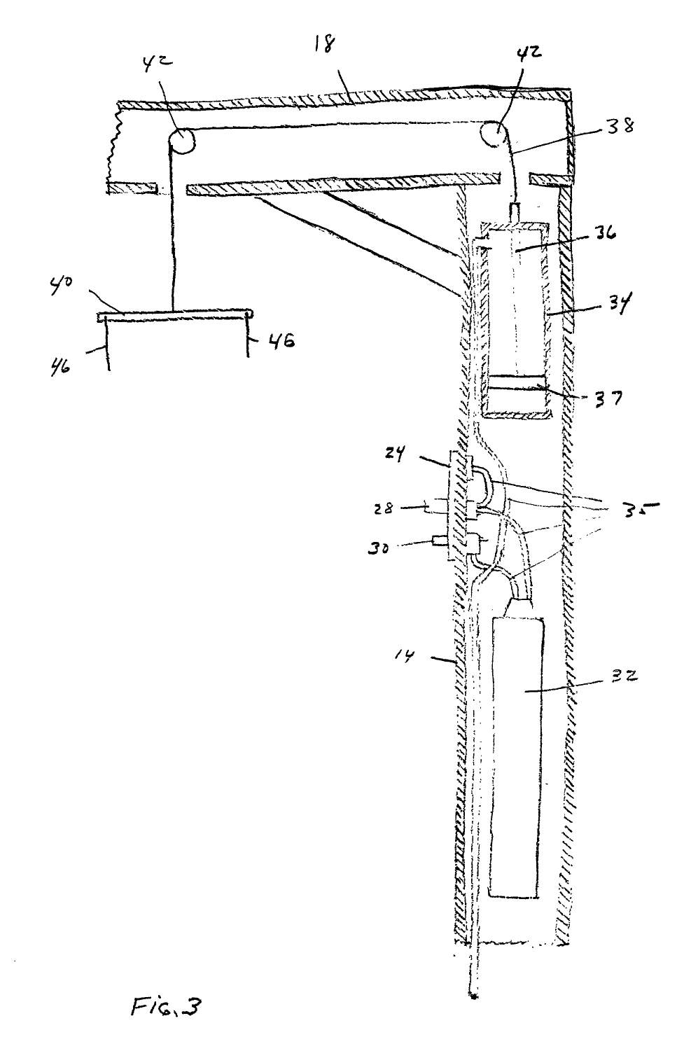

As shown in FIG. 5, a waist-wrapping, body support 44 has webbing and cables 46 attached to the body support extending away from a person's body. The opposite ends of webbing and cables 46 are removably connected to opposite ends of exercise bar 40 as shown in FIG. 1 so as to securely hold a person in position relative to the exercise bar.

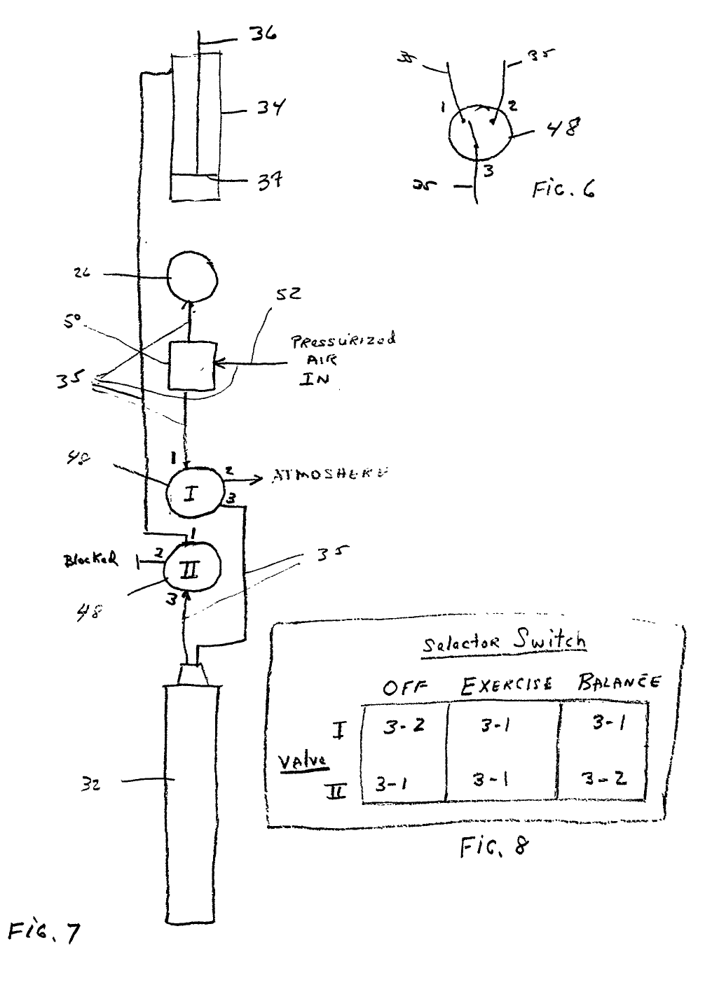

Two three-way pneumatic valves 48 are used in the invention. A schematic of a three-way pneumatic valve 48 is shown in FIG. 6. As shown, pneumatic tubing 35 connected to port 3 can be switched by valve 48 to provide a pneumatic path between port 3 and either port 1 or port 2 with the non-used port blocked as the valve is switched. One three-way pneumatic valve 48 of the present invention is labeled I in FIGS. 7 and 8; the other valve is labeled II in the same Figs. The ports on each valve are labeled 1, 2, or 3 consistent with the same labeling of ports shown in FIG. 6.

As shown in FIG. 7, valve II has a pneumatic tube 35 connecting pressure tank 32 to port 3 of the valve 48. Port 1 of the II valve has a pneumatic tube 35 connected to the pressurizing side of pneumatic cylinder 34. Port 2 is always plugged. Valve I, on the other hand, has port 3 connected to pressure tank 32. Port 1 is connect to pressure regulator 50; while port 2 is left open to vent pressure to the atmosphere. Incoming pressurized air 52 is introduced to regulator 50 before being routed to port 1 of valve I.

There are three positions on selector mode 30 corresponding to “Off,” “Exercise,” and “Balance.” “Off” releases pressure from pneumatic cylinder 34. “Exercise” lets shaft 35 (with associated piston 37) adjust to vertical movement of a person by allowing piston 37 to move in pneumatic cylinder 34 under pressurized inputs to the cylinder. “Balance” traps air in the pneumatic cylinder 34 to prevent piston 37 from moving from a position where the pull of cable 38 is counteracted by the pressure force exerted on the piston 37. To achieve these three positions, valves I and II have to be switched by selection mode 30, shown in FIG. 4, so as to achieve the port connections shown in FIG. 8.

The effects of the switching of valve I and II as shown in FIG. 8 is now described. In the “Off” position, valve II connects cylinder 34 to tank 32 through port 1. Tank 32 is then vented to the atmosphere through valve I with air venting out through port 2. In the “Exercise” position, pressurized air 52 flows from regulator 50, through port 1 of valve I, then on through port 3 to tank 32. Then the pressurized air can flow from tank 32, through port 3 of valve II, then out port 1 of valve II on to cylinder 34 where it can push piston 37 toward control panel 24. In the “Balance” position, port 1 of valve II blocks pressure from exiting cylinder 34 while ports 3-2 block pressurized air from leaving pressure tank 32. Valve I shifts incoming pressurized air 52 into tank 32 through a port 1-3 path. Regulator 50 cuts off adding additional pressurized air if an excessive pressure builds up in tank 32 in this instance.

In operation, a person gets into body support 44 so as to place their weight on exercise bar 40. Selector mode 30 is turned to “Exercise” to permit pressurized air 52 to enter pneumatic cylinder 34 and force piston 37 to retract toward control panel 24. As piston 37 moves, it places a strain on cable 38 which in turn lifts exercise bar 40 (the amount of strain is adjusted by regulator adjustor 28 shown in FIG. 4). This action hoists the person by body support 44 so that some weight is taken off their feet. If a person exercises with this position of selector mode 30 selected, any vertical movement (within the travel limits of piston 37) is compensated for by movement of piston 37 with the volume of pressurized air (but not necessarily the pressure) changing above the piston as the piston moves. A person experiences a substantially constant reduction of weight on their feet throughout the vertical displacement of their body during the exercise period.

When it is desired to end this exercise period, selector mode 30 is switched to “Balance.” This in effect seals off the pressure side of piston 37 so that the pull downward of a person's weight is counteracted by the nearly-constant, pressurized volume within cylinder 34. A person's weight is just suspended at a height that is established by counteracting forces between cable 38 and the pressure above piston 37.

When it is desired to end all exercises, selector mode 30 is first switched to “Exercise” and the pressure lowered with regulator adjustor 28. When all the pressure is relieved, selector mode 30 is switched to “Off”. In effect, this releases all pressure in cylinder 34 to the atmosphere permitting piston 37 to move away from control panel 24 and cable 38 to extend toward the floor. The person can than get out of body support 44.

The method of using this apparatus is essentially as described above. After a person gets into body support 44, he selects “Exercise” on selector switch 30, FIG. 4, to gradually raise some of the weight off his feet. He determines how much weight to take off his feet by adjusting regulator adjuster 28, FIG. 4. With this adjustment, the person can have vertical movement during any exercises (within the range of piston 37) to keep approximately the same weight off his feet throughout the vertical cycle.

When the person no longer wants vertical movement support, he can select “Balance” with selector switch 30, FIG. 4. This prevents pneumatic cylinder 34 from expelling air above piston 37 to essentially “lock” the person at a given height position. Any bouncing by the person exercising will be felt as a soft cushioning because the person will be slightly compressing and relaxing the pressure above piston 37 in pneumatic cylinder 34 during the bounce.

When the person wants to get out of exercise hoist 10, the person selects “Exercise” on selector switch 20 and then lowers the pressure with regulator adjustor 28. The person can then select “Off” on selector switch 30, FIG. 4. Any pressurized air in the system is vented to the atmosphere. The person can then remove body support 44 and discontinue using exercise hoist 10.

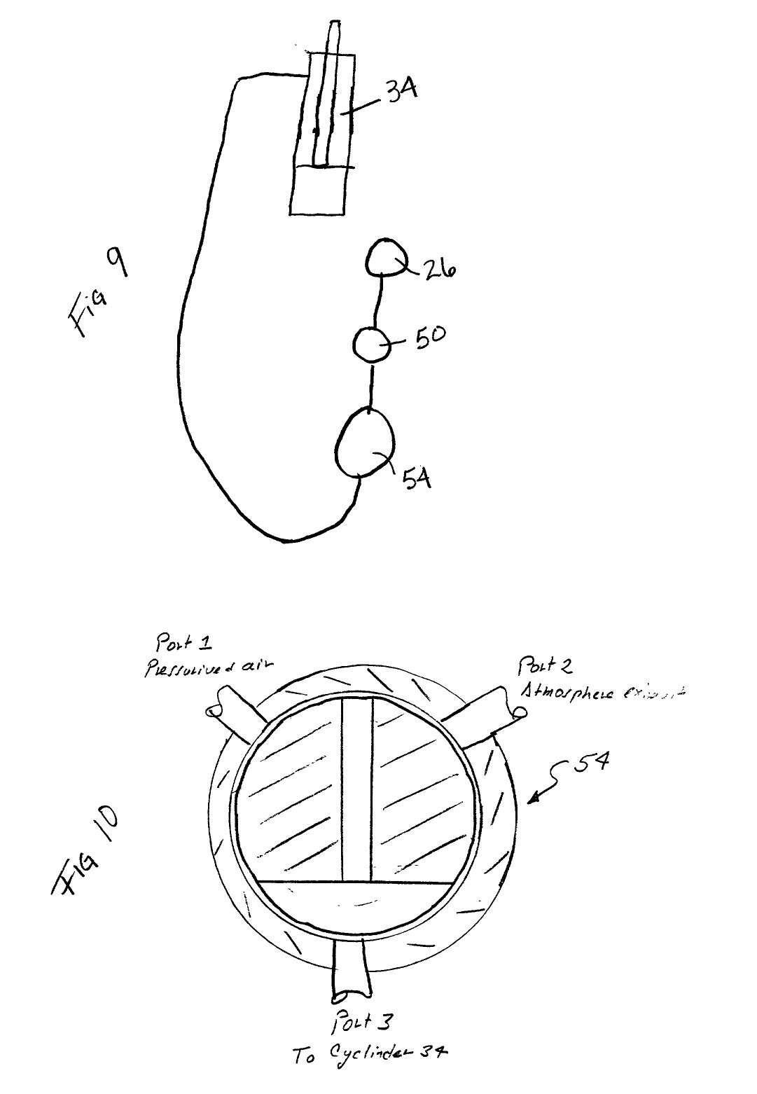

A second embodiment of the present invention is shown in FIG. 9. This second embodiment utilizes a single valve 54 which replaces the two valves 48 in the first embodiment. Valve 54 is shown in FIG. 10, although other configurations could be used equally as well. Valve 54 is controlled by selection mode switch 30 to selectively connect port 1 (pressurized air inlet port) to port 3 (cylinder 34 port), the “Exercise” mode. When switch 30 is turned to the “Off” mode, valve 54 is positioned to connect port 2 (atmosphere exhaust port) to port 3. When switch 30 is turned to the “Balance” mode, valve 54 is positioned to block all three ports 1, 2 and 3.

With regard to FIG. 9, cylinder 74 is fluidly connected to port 3 of valve 54. An air pressure source (not shown) is fluidly connected with regulator 30, as in the first embodiment, which in turn is connected to port 1 of valve 54. A pressure gauge 26 is connected to regulator 30 as in the first embodiment.

This second embodiment functionally operates the same as the first embodiment and is operated by a user in a similar manner.

While the fundamental novel features of the invention have been shown and described, it should be understood that various substitutions, modifications and variations may be made by those skilled in the art without departing from the spirit or scope of the invention. Accordingly, all such modifications or variations are included in the scope of the invention as described by the following claims:

I claim:

1. An exercise device comprising:
an assembly adapted to selectively unweight a user while exercising.
